(19) United States
(12) Patent Application Publication
(10) Pub. No.: US 2004/0024157 A1
(43) Pub. Date: Feb. 5, 2004

(54) Optical member, polymerizable composition and method for preparing thereof

(75) Inventors: Masaki Okazaki, Minami-ashigara-shi (JP); Hiroki Sasaki, Minami-ashigara-shi (JP)

Correspondence Address: SUGHRE MION, PLLC, 2100 Pennsylvania Avenue, NW, Washington, DC, 20037-3213, US

(73) Assignee: FUJI PHOTO FILM CO., LTD.

(21) Appl. No.: 10/328,009

(22) Filed: Dec. 26, 2002

(30) Foreign Application Priority Data
Dec. 25, 2001 (JP) 392153/2001
Dec. 25, 2001 (JP) 392026/2001
Feb. 27, 2002 (JP) 050835/2002

(51) Int. Cl. C08F 118/02

(52) U.S. Cl. 526/319

(57) ABSTRACT

A novel optical member is disclosed. The optical member comprises a region having a distributed refractive index, wherein the region comprising a polymer having deuterium-substituted carbon atoms and halogen-substituted carbon atoms. A novel composition for preparation of optical member is also disclosed. The composition comprises an ester of an alcohol having a halogen-substituted carbon atom and a propenoic acid or derivative thereof having a deuterium-substituted carbon atom, a polymerization initiator for the ester and an organic compound having a low molecular weight and a different refractive index from that of a polymer of the ester.

### TECHNICAL FIELD

The present invention belongs to a technical field of plastic optical members, in particular belongs to a technical field of plastic optical members preferably applicable to plastic light fibers, light guides, or optical lenses, and polymerizable compositions and methods for producing the plastic optical members.

### RELATED ART

In recent years, plastic optical member is widely used for various applications including optical fiber and optical lens, by virtue of its advantages such that allowing more simple producing and processing at a lower cost as compared with quartz-base optical member having the same structure. The plastic optical fiber is slightly inferior to quartz-base fiber since the entire region of the element fiber thereof is made of plastic material and has, as a consequence, a little larger transmission loss, but superior to the quartz-base optical fiber in that having an excellent flexibility, lightweight property, workability, better applicability in producing a large bore diameter fiber and a lower cost. The plastic optical fiber is thus studied as a transmission medium for optical communication which is effected over a distance relatively as short as allowing such large transmission loss to be ignored.

The plastic optical fiber generally has a center core (referred to as “core region” in the specification) made of an organic compound and comprises a polymer matrix, and a outer shell (referred to as “clad region” in the specification) made of an organic compound having a refractive index differing from (generally lower than) that of the core region. In particular, the plastic optical fiber having a distributed refractive index along the direction from the center to the outside thereof recently attracts a good deal of attention as an optical fiber which can ensure a high transmission capacity.

The plastic optical fiber is obtained generally by forming a fiber base member (referred to as “preform” in the specification) and then drawing the preform. In this method, a polymerizable monomer such as methyl methacrylate (MMA) is placed in a polymerization vessel having a sufficient rigidity, which monomer is then polymerized while rotating the vessel to thereby form a cylinder made of a polymer such as poly methacrylate (PMMA). The cylinder corresponds to the clad region.

Next, a core region is produced in the hollow of the cylinder. According to a method disclosed in International Patent Publication No. WO93/08488, in the hollow space of the cylinder, a monomer such as MMA, which is a source material for the core region, a polymerization initiator, a chain transfer agent, a refractive index adjusting agent and so forth are placed, and interfacial gel polymerization of the mixture is allowed to proceed in the inner space of the cylinder so as to produce the core region, to thereby obtain the preform. The core region thus formed by the interfacial gel polymerization process has a concentration distribution of the refractive index adjuster or so contained therein, and based on which concentration distribution a distribution in the refractive index is produced. Drawing of thus-obtained preform in a hot atmosphere will produce the plastic optical fiber having a distributed refractive index.

However as described in the above, the plastic optical fiber is disadvantageous in that causing a large light transmission loss. The light transmission loss of the plastic optical fiber is mainly ascribable to stretching vibration of carbon-hydrogen bond present in the material. The vibration is demonstrated as having a large absorption intensity, and tends to be associated with higher harmonic absorption. In light transmission in near-infrared region, light absorption due to such higher harmonic wave will cause the transmission loss. International Patent Publication WO93/08488, for example, has disclosed that deuteration of the material, that is, exchanging of carbon-hydrogen bonds in the material to carbon-deuterium bonds could reduce the light transmission loss. However, materials, which are enough deuterated to have lower loss of light transmission, are very expensive and such materials cannot fit to practical use. Moreover, if fibers are made of hygroscopic polymers and contain H₂O molecules, light transmission loss occurs due to harmonic absorption of O—H vibration. Deuterated polymers are as same as non-deuterated polymers in properties other than above mentioned optical property, more specifically, the other properties are not influenced by deuteration. Since acrylic based polymers are hygroscopic, deuterated acrylic based polymers are also hygroscopic. When plastic optical fibers made of either deuterated or non-deuterated acrylic based polymers are used, light transmission loss may increase due to harmonic absorption of O—H vibration.

On the other hand, introduction of fluorine in place of deuterium so as to exclude carbon-hydrogen bonds as disclosed in Unexamined JP-A No-60-260905 (the term in “JP-A” as used herein means an “unexamined published Japanese patent application) cannot provide a desirable composition since it may degrade the refractive index, heat resistance and mechanical properties. As for refractive-index-distributed plastic optical fiber, another problem resides in that it may become difficult to obtain a desirable refractive-index-distributed structure if the refractive index of an employed polymer is too high (or does not fall within an appropriate range), which also results in insufficient light transmission property. Using a fluorine-substituted polymer, the refractive index may lower well, however, the solubility of additives (e.g., refractive index adjusting agent), which may be used in order to create the refractive-index-distributed structure, for such a fluorine-substituted polymer will also lower so that it is hardly to form a satisfactory refractive-index-distributed structure. It is also anticipated for the method of creating refractive index distribution based on concentration distribution of the refractive-index-adjusting agent that such agent may function as a plasticizer, which may lower the glass transition point of the optical fiber and thus degrade the heat resistance.

### SUMMARY OF THE INVENTION

One object of the present invention is to provide an optical member having a reduced light transmission loss and an excellent light transmission performance, and can be manufactured at a low cost. Another object of the present invention is to provide a method and a composition for preparing an optical member having an excellent light transmission performance at a low cost.

One embodiment of the present invention relates to a polymerizable composition for optical member comprising an ester of an alcohol having a halogen-substituted carbon atom and a propenoic acid or derivative thereof, having a deuterium-substituted carbon atom; a polymerization initiator for the ester; and an organic compound having a low molecular weight and a different refractive index from that of a polymer of the ester.

By polymerizing the composition according to this embodiment so as to produce a gradient in the concentration of the organic compound having a low molecular weight, an optical member within which the refractive index varies along with such concentration distribution can be obtained. Since the resultant optical member has a matrix containing a monomer unit in which hydrogen atoms of the C—H bonds thereof are substituted with halogen atoms and deuterium atoms, so that the optical member is ensured with mechanical properties and optical properties well balanced therein.

As one embodiment of the present invention, there are provided the composition wherein the propenoic acid of derivative thereof is a (meth)acrylic acid or derivative thereof, and the composition wherein the halogen atom is a fluorine or chlorine atom, and the composition wherein the alcohol is represented by Formula (1) below;

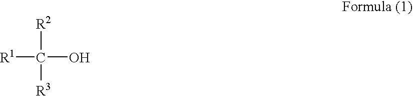

where in the formula, R¹ is a halogen atom or an alkyl group substituted by at least one halogen atom, and R² and R³ independently represent a hydrogen atom, deuterium atom or alkyl group are provided.

Another embodiment of the present invention relates to a polymerizable composition for optical member comprising a plural polymerizable monomers of which homopolymers have different refractive indices by 0.005 or more each other, at least one of which is a compound having a halogen-substituted carbon atom and a deuterium-substituted carbon atom and a polymerization initiator for the polymerizable monomers.

By polymerizing the composition according to this, embodiment so as to produce a gradient in the copolymerization ratio of such plural monomers, an optical member within which the refractive index is distributed along with the distribution of such copolymerization ratio can be obtained. Since the resultant optical member has a matrix containing a monomer unit in which hydrogen atoms of the C—H bonds thereof are substituted with halogen atoms and deuterium atoms, so that the member is ensured with mechanical properties and optical properties well balanced therein.

Still another embodiment of the present invention relates to an optical member comprising a region having a distributed refractive index, wherein the region comprises a polymer having deuterium-substituted carbon atoms and halogen-substituted carbon atoms.

As one embodiment of the present invention, there are provided the optical member comprising an organic compound having a low molecular weight in the region having a distributed refractive index, wherein refractive index in the region is distributed along with the concentration distribution of the organic compound; the optical member wherein the polymer is a copolymer of a plural propenoic ester derivatives respectively having a halogen-substituted carbon atom and a deuterium-substituted carbon atom, and refractive index in the region is distributed along with the distribution of the copolymerization ratio of the plural propenoic ester derivatives; the optical member wherein refractive index in the region is distributed along with the direction from the center to the outside in cross section thereof; the optical member wherein the amount of hydrogen atoms contained in the polymer is 60 mg/g or below; and the optical member wherein a ratio of the number of halogen atoms contained in the polymer to the total number of hydrogen and deuterium atoms contained in the polymer is 0.10 to 0.90.

In the present embodiment, the polymer may have a major chain directly substituted with deuterium atoms or bound with deuterium-substituted carbon atoms, and side chains containing halogen-substituted carbon atoms. The polymer is preferably a polymer based on a propenoic acid or derivative thereof, and preferably contains the repetitive unit expressed by Formula (2) below:

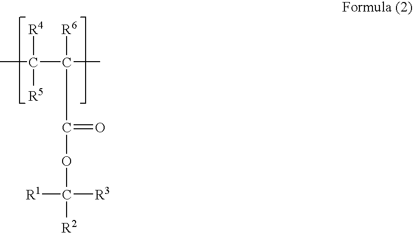

wherein in the formula, R¹ is a halogen atom or an alkyl group substituted by at least one halogen atom; R² and R³ independently represent a hydrogen atom, deuterium atom or alkyl group; and R⁴, R⁵ and R⁶ independently represent a hydrogen atom, deuterium atom, CH₃ group or CD₃ group, where at least one of which represents a deuterium atom or CD₃ group.

As another embodiment of the present invention, there are provided the optical member comprising a core region made of the polymer and a clad region cladding the core region and having different refractive index from that of the core region; and the optical member wherein the clad region is made of the polymer having halogen-substituted carbon atoms and/or deuterium-substituted carbon atoms.

The another embodiment relates to an optical member comprising a region prepared by polymerization of a composition comprising at least one ester of an alcohol having a halogen-substituted carbon atom and a propenoic acid or derivative thereof having a denterium-substituted carbon atom and a polymerization initiator for the ester; wherein refractive index in the region is distributed along with the concentration distribution of at least one component of the composition. In the embodiment wherein the composition comprises an organic compound having a low molecular weight for adjusting refractive index, refractive index in the region may be distributed along with the concentration distribution of the organic compound. In the embodiment wherein the composition comprises a plural polymerizable monomers of which homopolymers have different refractive indices by 0.005 or more each other, at least one of which is a compound having a halogen-substituted carbon atom and a deuterium-substituted carbon atom, refractive index in the region may be distributed along with the distribution of copolymerization ratio of the monomers.

The another embodiment of the present invention relates to a method for preparing an optical member comprising a region having a distributed refractive index, comprising polymerization of a composition comprising at least a polymerizable monomer having a halogen-substituted carbon atom and a deuterium-substituted carbon atom and a polymerization initiator for the polymerizable monomer, thereby preparing the region.

As one embodiment of the present invention, there are provided the method wherein the composition comprises an organic compound having a low molecular weight, and refractive index in the region is distributed along with the concentration distribution of the organic compound; and the method wherein the composition comprises a plurality of polymerizable monomers of which homopolymers have different refractive indices by 0.005 or more each other, at least one of which is a compound having a halogen-substituted carbon atom and a deuterium-substituted carbon atom, and refractive index in the region is distributed along with the distribution of copolymerization ratio.

### DETAILED DESCRIPTION OF THE INVENTION

The present invention will be detailed hereinafter.

The description will be started with the polymer used for the optical member of the present invention (which may occasionally be referred to as “polymer for optical member”, hereinafter).

The polymer for optical member contains deuterium-substituted carbon atoms and halogen-substituted (preferably chlorine- or fluorine-substituted, and more preferably fluorine-substituted) carbon atoms. The polymer according to a preferred embodiment has a major chain directly substituted with deuterium atoms or bound with deuterium-substituted carbon atoms, and also having side chains containing halogen-substituted carbon atoms (where the side chain described herein is typically a bound chain linked through an ester bond (—C(═O)—O—) to the major chain for the case where the polymer is a propenoic acid ester polymer). The polymer for optical member is preferably a polymer based on propenoic acid or derivatives thereof, and is more preferably a polymer comprised of an acrylic acid ester or methacrylic acid ester. The halogen atoms substituting on the carbon atoms are preferably fluorine atom or chlorine atom, where the fluorine atom is more preferable. In a preferred embodiment, the polymer for optical members is an acrylic-ester-base polymer or methacrylic-ester-base polymer containing the repetitive unit expressed by the Formula (2) below:

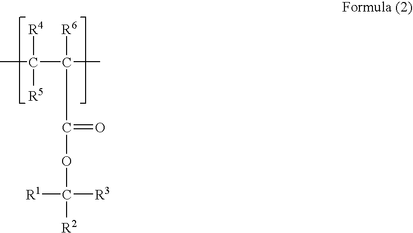

where in the formula, R¹ is a halogen atom or an alkyl group substituted by at least one halogen atom; R² and R³ independently represent a hydrogen atom, deuterium atom, halogen atom or alkyl group.

The halogen-substituted alkyl groups represented by R¹ include those having a straight-chained, branched or cyclic structure, or any combinations thereof. The number of carbon atoms of the alkyl group is preferably 1 to 10, and more preferably 1 to 4. The alkyl group may also have a substituent other than halogen atom, which substituent can be selected from alkylcarbonyloxy group, alkylsulfonyloxy group, alkyloxy group, arylcarbonyloxy group, arylsulfonyloxy group, aryloxy group and the like. A part of hydrogen atoms in these substituents may be substituted with deuterium atoms.

In the formula, the alkyl groups represented by R² and R³ include those having a straight-chained, branched or cyclic structure, or any combinations thereof. The number of carbon atoms of the alkyl group is preferably 1 to 10, and more preferably 1 to 4. The alkyl group may further be substituted with a halogen atom or with other substituents, where specific examples of such substituents may be the same with those listed for R¹.

R¹ preferably is a halogen atom or an alkyl group substituted by at least one halogen atom, and the latter is more preferable. The halogen atom in this case is preferably fluorine atom.

In the formula, R⁴, R⁵ and R⁶ independently represent a hydrogen atom, deuterium atom, CH₃ group or CD₃ group, where at least one of which represents a deuterium atom or CD₃ group.

Specific examples of the structural unit expressed by the Formula (2) will be listed below, where it is to be noted that the polymer for optical member used in the present invention is by no means limited to these specific examples.

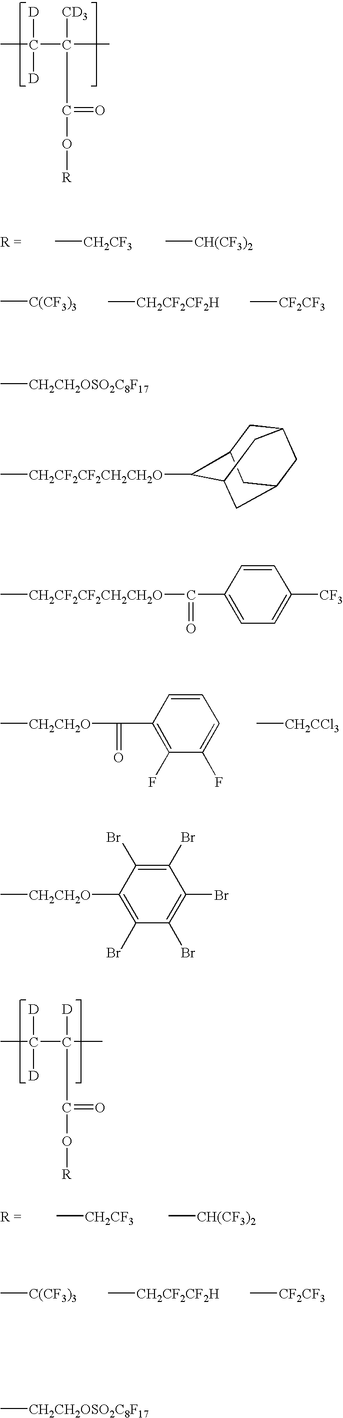

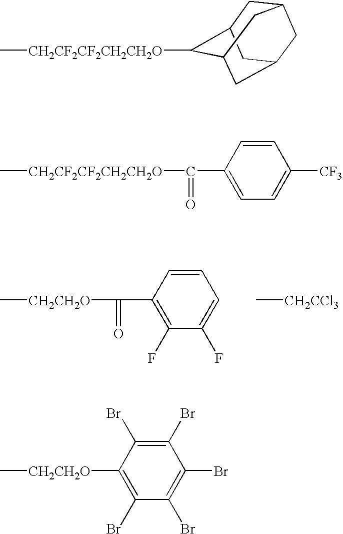

The polymer for optical member can be prepared by polymerizing one or more esters of an alcohol having at least a halogen-substituted carbon, and a propenoic acid or derivatives thereof having at least a deuterium-substituted carbon atom (where the ester may occasionally be referred to as “deuterated and halogenated propenoic acid ester”); or by copolymerizing at least one of the foregoing propenoic acid ester and other monomer.

While there is no specific limitation on the structure of the alcohol, a preferable structure is such that containing halogen atoms as substituting 20% or more (more preferably 30 to 100%, and still more preferably 50 to 100%) of the hydrogen atoms of a basic alcohol not substituted by halogen atoms. The halogen atom is preferably fluorine atom or chlorine atom, where the fluorine atom is more preferable. The alkyl region of the alcohol may have any of straight-chained, branched and cyclic structures, or any combinations thereof. The alkyl region may have a substituent other than halogen atom, where examples of the substituent include alkylcarbonyloxy group, alkylsulfonyloxy group, alkyloxy group, arylcarbonyloxy group, arylsulfonyloxy group, aryloxygroup or the like. A part of the hydrogen atoms may be substituted by deuterium atoms.

The preferable example of the alcohol is represented by Formula (1) below:

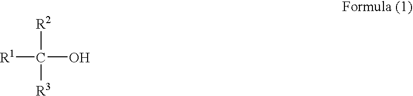

where in the formula, R¹, R² and R³ are the same with those listed for the Formula (2), and the same will apply to the preferable ranges thereof.

There is no specific limitation also on the structure of propenoic acid or derivatives thereof, where a preferable structure is such that containing deuterium atoms as substituting 20% or more (more preferably 30 to 100%, and still more preferably 50 to 100%) of the hydrogen atoms of basic propenoic acid or derivatives thereof not substituted by deuterium atoms.

Specific examples of available propenoic acid esters are listed below, where it is to be noted that the present invention is by no means limited by these specific examples.

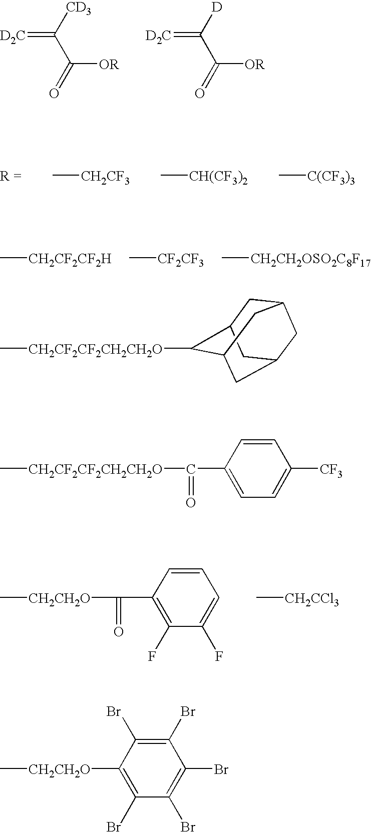

The deuterated and halogenated propenoic acid esters can be synthesized by any combinations of known deuteration and estrification reactions. The synthesis can be carried out according to the descriptions, for example, in Nagai et al., J. Poly. Sci., 62, 95-98,and Examined Japanese Patent Publicaion Nos. (Sho)57-51645 and (Hei)6-80441.

When the polymer is prepared by copolymerization of two or more polymerizable in order to form a region having a distribution of refractive index depending on a distribution of copolymerization ratio, it is preferable to use two or more monomers differing in refractive index as the major components. More specifically, it is preferable to use a plurality of polymerizable monomers of which homopolymers have different refractive indices by 0.005 or more each other. In a plurality of such polymerizable monomers, content of the deuterated and halogenated propenoic acid ester derivative is preferably 50 wt % or more of total weight of the polymerizable monomers, more preferably 60 wt % or more, and still more preferably 70 wt % or more.

Other monomers used together with the deuterated and halogenated propenoic acid ester derivative include non-deuterated and non-halogenated propenoic acid ester derivatives and the monomers listed below:

(a) styrene-base compounds

styrene, α-methylstyrene, chlorostyrene, bromostyrene; and

(b) vinyl esters

vinyl acetate, vinyl bezoate, vinylphenyl acetate, vinyl chloroacetate, etc.

The amount of hydrogen atoms contained in the polymer for optical member is preferably 60 mg/g or bellow (more preferably 50 mg/g or below, and still more preferably 20 mg/g or below) The amount of hydrogen atoms contained in the polymer can fall within the foregoing range by replacement of the carbon-hydrogen bonds in the polymer with carbon-deuterium bonds and carbon-halogen bonds.

Ratio of the number (N_{X}) of halogen atoms contained in the polymer to the total number (N_{H}+N_{D}) of hydrogen and deuterium atoms contained in the polymer, namely the value of {(N_{X})/(N_{H}+N_{D})} preferably falls within a range from 0.10 to 0.90, more preferably 0.15 to 0.60, and still more preferably 0.20 to 0.49. Increase in the number of deuterium atoms allows hygroscopicity of the polymer to remain at a high level, which tends to increase transmission loss due to vibration of oxygen-hydrogen bond of water absorbed in the polymer, and tends to raise the production cost. On the other hand, increase in the number of halogen atoms degrades physical properties such as heat resistance or solubility of the refractive index adjusting agent, which tends to lose the reducing effect in light transmission loss. Using the polymer of which the ratio {(N_{X})/(N_{H}+N_{D})} is within the foregoing range, an optical member having an excellent moisture resistance, heat resistance, and reducing effect of light transmission loss at a low cost can be prepared.

Specific examples of the polymer will be enumerated below, where the present invention is by no means limited to these specific examples. It is to be noted that the specific examples include not only homopolymers containing given units but also copolymers containing two or more species of the units in an arbitrary ratio so far as the amount of hydrogen atoms is suppressed to 60 mg/g or below, and more preferably the ratio {(N_{X})/(N_{H}+N_{D})} falls within a range from 0.10 to 0.90. For a typical case where the repetitive units containing only deuterium atoms are used (e.g., unit (11)), a possible specific example of the polymer will be a copolymer having also the halogen-containing repetitive units (e.g., unit (1)) copolymerized therewith at an arbitrary ratio. For another typical case where the repetitive units containing only halogen atoms are used (e.g., unit (9)), a possible specific example of the polymer will be a copolymer having also the deuterium-containing repetitive units (e.g., unit (11)) copolymerized therewith at an arbitrary ratio. For still another typical case where the repetitive units containing neither halogen atoms nor deuterium atoms are used, a possible specific example of the polymer will be a copolymer having also the deuterium- and/or halogen-containing repetitive units copolymerized therewith at an arbitrary ratio.

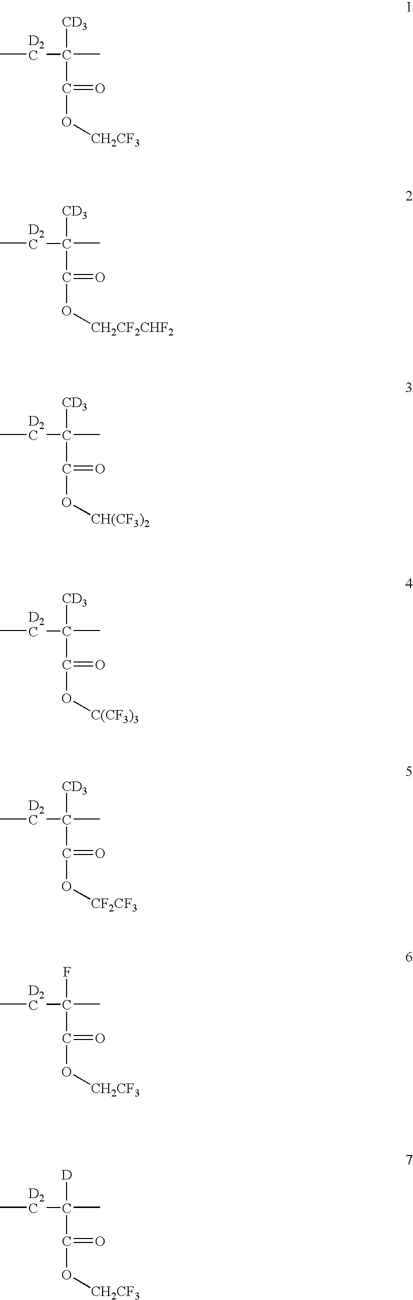

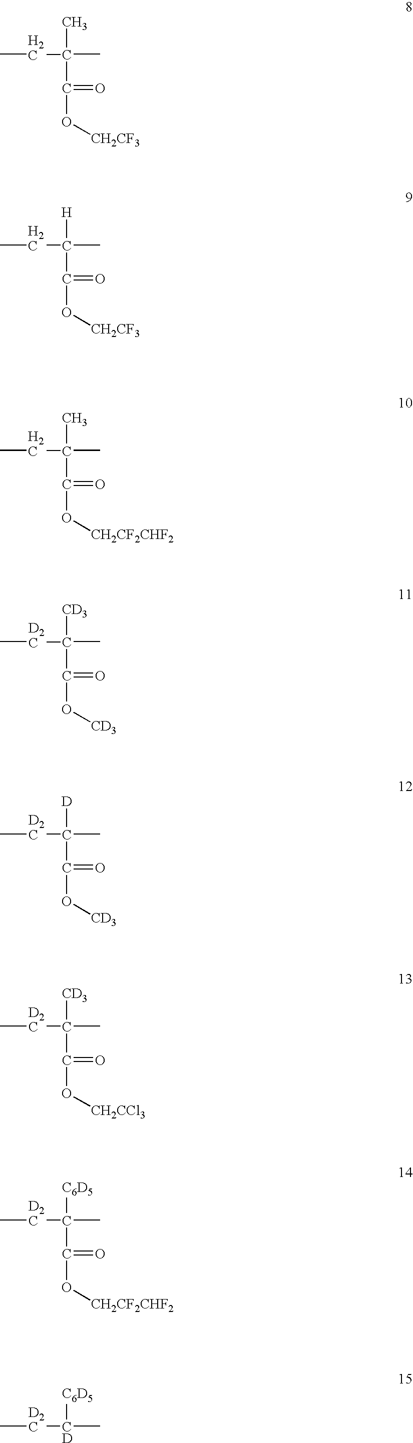

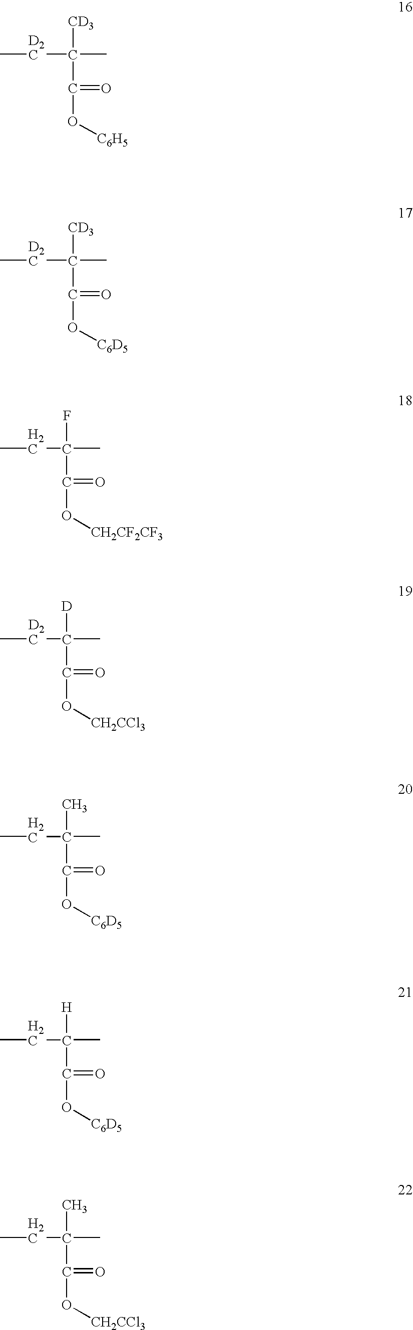

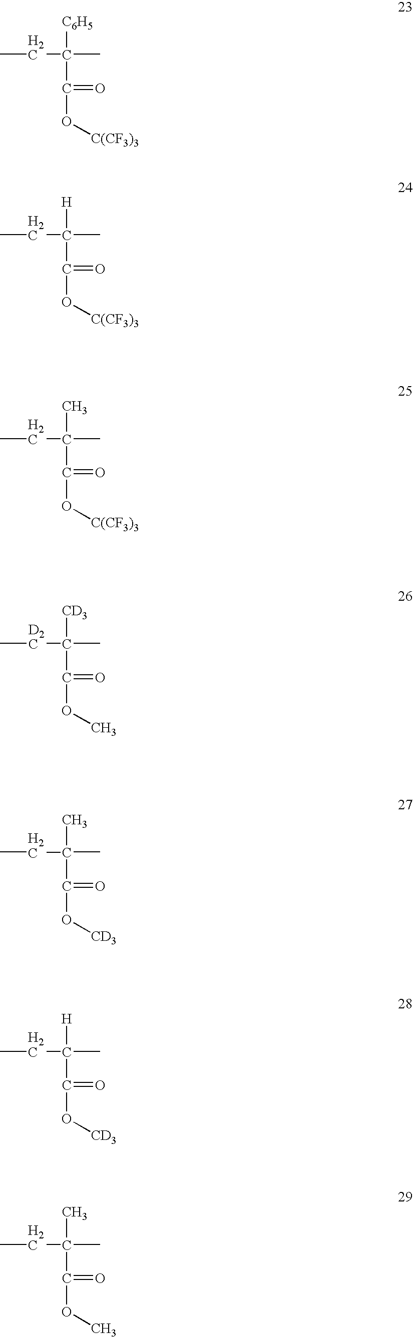

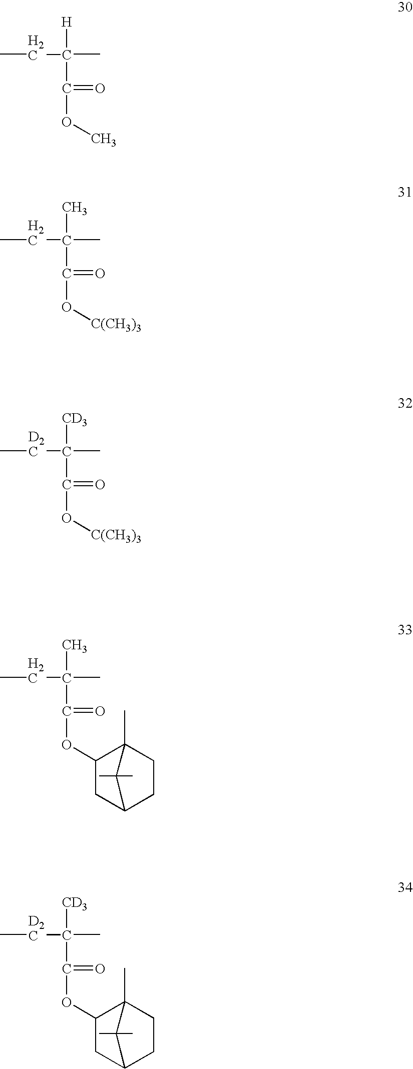

The first embodiment of the optical member according to the present invention relates to an optical member having a region comprising the above-described polymer as a matrix and an organic compound having a low molecular weight. And the refractive index in the region is distributed along with the concentration distribution of such a low-molecular-weight organic compound.

The optical member according to the present invention can be prepared by polymerization of the polymerizable composition, which comprises at least one species of deuterated and halogenated propenoic acid esters, a polymerization initiator, and a low-molecular-weight organic compound having a refractive index different from that of the polymer of the foregoing esters. When heat and/or light is irradiated to the polymerizable composition, radicals and the like are generated from the initiator, thereby inducing the polymerization of the ester. Since the polymerizable composition contains the low-molecular-weight organic compound, the refractive-index-distributed structure can readily be obtained by controlling the proceeding direction of the polymerization, typically in the interfacial gel polymerization process described later, so as to create a concentration gradient of the low-molecular-weight organic compound.

The optical member according to the first embodiment has the refractive-index-distributed region having a matrix in which part of carbon-hydrogen bonds (preferably part of carbon-hydrogen bonds contained in the major chain or in any substitutive groups bound to such major chain) is replaced with carbon-deuterium bonds, and in which another part of carbon-hydrogen bonds (preferably part of carbon-hydrogen bonds contained in the side chains) is replaced with carbon-halogen bonds, so that light transmission loss due to light absorption by stretching vibration of the carbon-hydrogen bonds can be reduced. Another advantage of the above-described optical member resides in that it can be produced at a cost lower than that for the resin having the carbon-hydrogen bonds thereof replaced with carbon-deuterium bonds in the same ratio, which ensures reduction in light transmission loss at a lower cost, The foregoing polymer for optical member has at least a part of carbon atoms thereof substituted with halogen atoms (more preferably fluorine atoms), and thus has a refractive index intrinsically lower than that of non-halogen-substituted (preferably non-fluorine-substituted) polymer. This is is advantageous in readily creating a distribution of the refractive index by adding a refractive index adjusting agent (low-molecular-weight organic compound) so as to produce a concentration gradient.

In the present embodiment, the low-molecular-weight organic compound may function as a refractive index adjusting agent. As described in the International Patent Publication WO93/08488 or JP-A No. 5-173026, the refractive index adjusting agent has a solubility parameter which differs by 7 (cal/cm³)^{1/2} or less from that of the polymer produced by monomer, and is such that a refractive index of a composition containing the agent is different from (preferably higher than) that of a composition non-containing. The refractive index of the low molecular weight organic compound is different from that of the propenoic acid ester based polymer, and preferably differs 0.001 or above from that of the polymer. The distribution of the refractive index in the structure made of polymer can build based on the concentration distribution of the low molecular organic compound.

Any compounds having the foregoing properties, being stably compatible with the polymer, not polymerizing with the monomer, and being stable under polymerization conditions (heating, pressurizing, etc.) for the monomer which is a source material are available.

Examples of such available agent include benzyl benzoate (BEN), diphenyl sulfide (DPS), triphenyl phosphate (TPP), benzyl-n-butyl phthalate(BBP), diphenyl phthalate (DPP), biphenyl (DP), diphenylmethane (DPM), tricresyl phosphate (TCP), and Diphenyl sulfoxide (DPSO), where particularly preferable species are BEN, DPS, TPP and DPSO. These low molecular weight compounds may be used in any combination of two or more species.

It is to be noted that in this specification, expressions of “a low-molecular-weight organic compound” and “an organic compound having a low molecular weight” are used for any organic compounds other than polymers, however the expressions are also used for any dimers to decamers.

The desirable additional amount of the refractive index adjusting agent may be various according to how degree of increase in the refractive index the agent has or how relation between the agent and the matrix, however, in general, the desirable additional amount of the agent may be in a range of 1 to 30 wt. %, more desirably in a range of 3 to 25 wt. %, and furthermore desirably in a range of 5 to 20 wt. %, of the polymerizable composition.

The second embodiment of the optical member according to the present invention relates to an optical member having the region which comprises a copolymer of a plurality of propenoic acid esters individually containing deuterium-substituted carbon atoms and halogen-substituted carbon atoms. And the refractive index in the region is distributed along with the distribution of the copolymerization ratio of such plurality of propenoic acid esters.

Similarly to the first embodiment, also the present embodiment can reduce light transmission loss due to light absorption by stretching vibration of the carbon-hydrogen bond at a low cost. It is further possible in the present embodiment to readily create a distribution of the refractive index by creating a distribution of the copolymerization ratio of the plurality of polymerizable monomers.

The optical member of the present embodiment can be prepared by polymerization of a polymerizable composition which comprises a plurality of polymerizable monomers of which homopolymers have different refractive indices by 0.005 or more each other, and a polymerization initiator which induces polymerization of such polymerizable monomers, where at least one of the polymerizable monomers comprises a compound which has a halogen-substituted carbon atom and deuterium-substituted carbon atom. When heat and/or light is irradiated to the polymerizable composition, radicals and the like are generated form the polymerization initiator, thereby inducing polymerization of the polymerizable monomers. Since the polymerizable composition comprises the plurality of polymerizable monomers of which homopolymers have different refractive indices by 0.005 or more each other, the refractive-index-distributed structure can readily be obtained by controlling the proceeding direction of the polymerization, typically in the interfacial gel polymerization process described later, so as to create a gradient of the monomer concentration to thereby create a distribution of the copolymerization ratio. Methods of creating the gradient in monomer concentration are roughly classified into those based on difference in the reactivity ratio of the monomers as disclosed in Examined Japanese Patent Publication No. 54-30301 and JP-A No. 61-130904; and those based on diffusion properties of the monomers (differences in the specific volume or solubility parameters) in gel as disclosed in Japanese Patent Publication No. 3010369, where the latter is more preferable from the viewpoints of transmission loss and desirable distribution profile of the refractive index.

More specifically, it is necessary that two arbitrary monomers Mₓ and Mₓ₊₁ out of a plurality of such monomers having specific volumes of Vₓ and Vₓ₊₁, respectively, satisfy the relation expressed by formula (1); or these monomers Mₓ and Mₓ₊₁, having solubility parameters of δₓ and δₓ₊₁, respectively, satisfy the relation expressed by formula [II], where δₚ is a solubility parameter of a polymer composing the gel.

$$\begin{matrix}\vert \frac{{V}_{x} - {V}_{x + 1}}{{v}_{x}} \vert > 0.01 & [ I ] \\ \frac{\vert {δ}_{x} - {δ}_{x + 1} \vert}{{δ}_{p}} \times 100 ( \% ) > 0.2 ( \% ) & [ II ]\end{matrix}$$

In addition, it is preferable, in any of the foregoing radical-copolymerizable monomers, that a value “r” of monomer reactivity ratio is 0.2 or larger, and more preferably 0.5 or larger. It is to be noted that monomer reactivity ratios r₁ and r₂ respectively represent ratios of polymerization velocity coefficients k₁₁/k₁₂ and k₂₂/k₂₁ in copolymerization reactions of two arbitrary monomers (M₁, M₂) expressed by the formulae below.

M₁·+M₁→M₁· reaction velocity: k₁₁[M₁·][M₁];

M₁·+M₂→M₂· reaction velocity: k₁₂[M₁·][M₂];

M₂·+M₁→M₁· reaction velocity: k₂₁[M₂·][M₁]; and

M₂·+M₂→M₂· reaction velocity: k₂₂[M₂·][M₂];

where [M₁·], [M₂·], [M₁] and [M₂] respectively represent a polymer growth radical M₁· of the monomer M₁, a polymer growth radical M₂· of the monomer M₂, concentration of monomer M₁, and concentration of monomer M₂. There will be only two monomer reactivity ratios r₁ and r₂ when two species of the monomers are used, but the number of the ratios increased for example to 6 when three species of the monomers are to be used. Also for the case where three species of the monomers are to be used, it is preferable that each of 6 reactivity ratios has a value of 0.2 or larger, and more preferably 0.5 or larger.

In order to improve the heat resistance of the optical member according to the present invention, a monomer of which homopolymer has a high glass transition temperature (at least 90° C. or above, more preferably 100° C. or above, and still more preferably 110° C. or above) is used in the proper amount. Polymerization velocity and polymerization degree of the polymerizable monomers can be controlled by a polymerization modifier such as a polymerization initiator or a chain transfer agent optionally added, which successfully adjusts the molecular weight of the resultant polymer to a desired value. For a typical case where the obtained polymer is drawn to be provided as an optical fiber, such adjustment of the molecular weight allows the mechanical properties under drawing to fall within a desired ranger which also contributes to the productivity.

The polymerizable composition of the present invention comprises a polymerization initiator. The polymerization initiator can properly be selected in consideration of the monomer to be employed. Examples of radical polymerization initiators include peroxide compounds such as benzoyl peroxide (EPO), t-butylperoxy-2-ethylhexanate (PBO), di-t-butylperoxide (PBD), t-butylperoxyisopropylcarbonate (PBI) and n-butyl-4,4-bis (t-butylperoxy)valerate (PHV); and azo compounds such as 2,2′-azobisisobuthylonitrile, 2,2′-azobis(2-methylbuthylonitrile), and 1,1′-azobis(cyclohexane-1-carbonytrile). These polymerization initiators may be used in any combination of two or more species.

The polymerizable composition of the present invention preferably comprises a chain transfer agent. The chain transfer agent may mainly be for adjusting molecular weight of the polymer and for preventing physical properties of the obtained polymer from varying and un-homogenizing. The chain transfer agent can properly be selected in consideration of the monomer to be employed. Preferable examples of the chain transfer agents include alkylmercaptans (n-butylmercaptan, n-pentylmercaptan, n-octylmercaptan, n-laurylmercaptan, t-dodecylmercaptan, etc.) and thiophenols (thiophenol, m-bromothiophenol, p-bromothiophenol, m-toluenethiol, p-toluenethiol, etc.). Alkylmercaptans such as n-octylmercaptan, n-laurylmercaptan, and t-dodecylmercaptan are more preferable. It is also allowable to use the chain transfer agent having deuterium substituted for hydrogen atom on C—H bond. These chain transfer agents may be used in any combination of two or more species.

The desirable additional amounts of the polymerization initiator and the chain transfer may be various according to what a kind used, however, in general, the desirable additional amount of the polymerization initiator may be in a range of 0.005 to 0.5 wt. %, more desirably in a range of 0.001 to 0.5 wt. %, of the propenoic ester monomer; and the desirable additional amount of the chain transfer agent may be in a range of 0.10 to 0.40 wt. %, more desirably in a range of 0.15 to 0.30 wt. %, of the propenoic ester monomer.

Another possible strategy relates to addition of other additives to the polymerizable composition to an extent not degrading the light transmission property. For example, an additive can be added in order to improve the weatherability or durability. It is also allowable to add an emission inductive material for amplifying light signal for the purpose of improving the light transmission property. Since even attenuated light signal can be amplified by addition of such compound to thereby elongate the length of transmission, the compound is typically applicable to produce a fiber amplifier at a part of light transmission link.

In the first and second embodiments, it is preferable that the amount of hydrogen atoms contained the polymer is 60 mg/g or below, and it is more preferable that not only the amount of hydrogen atoms is 60 mg/g or below but also the ratio {(N_{X})/(N_{H}+N_{D}))} is 0.10 to 0.90.

The third embodiment of the present invention relates to an optical member comprising a core region having a distribution in the refractive index and a clad region cladding the core region and having a refractive index smaller than that of the core region. And the core region contains the foregoing polymer as the matrix, and also contains the low-molecular-weight organic compound, and where the refractive index is distributed along with the concentration distribution of such low-molecular-weight organic compound.

The fourth embodiment of the present invention relates to an optical member comprising a core region having a distribution in the refractive index and a clad region cladding the core region and having a refractive index smaller than that of the core region. And the core region comprises a copolymer of a plurality of propenoic acid ester derivatives individually containing deuterium-substituted carbon atoms and halogen-substituted carbon atoms, and has a distribution of the refractive index depending on the distribution of the copolymerization ratio of such plurality of propenoic acid ester derivatives.

In the third and fourth embodiments, the clad region should have a refractive index lower than that of the core region in order to confine light to be transmitted within the core region. On the other hand, the core region has a distribution of the refractive index, which decreases from the center to the periphery along the radial direction in cross section.

The optical members of the third and fourth embodiments can ensure a wide band of transmissible light and a large transmission capacity when it is used as an optical fiber. Additionally in the present embodiment, the refractive-index-distributed core region is formed using the foregoing polymer, that is, the polymer containing deuterium-substituted carbon atoms (preferably in the major chain) and halogen-substituted carbon atoms (preferably in the side chains), so that light transmission loss due to light absorption by stretching vibration of the carbon-hydrogen bonds can be reduced. In addition, since the polymer having a part of hydrogen atoms thereof substituted by halogen atoms, preferably by fluorine atoms, is used, an intrinsic refractive index of the core can be lowered as compared with the core comprised of a non-substituted polymer. This makes it more easier to obtain the refractive-index-distributed structure based on a concentration distribution of the low-molecular-weight organic compound as a refractive index adjusting agent or based on a distribution of the copolymerization ratio of the polymerizable monomers.

Assuming that the polymer for optical member is used as optical fiber or the like, there is no special limitation on the clad region to be provided so as to surround the core region, so far as it is formed using a polymer material capable of producing a region having a refractive index lower than that of the core region. In view of ensuring a desirable level of transparency, it is preferable to use a material compatible with the monomers composing the core region. That is, similarly to the core region, the clad region is preferably composed of the above-described polymer, such that containing deuterium-substituted or halogen-substituted (meth)acrylic acid ester or derivatives thereof as a major component. Forming S the core region with the polymer having deuterium-substituted carbon atoms and halogen-substituted carbon atoms, and forming the clad region with a fluorinated propenoic acid ester polymer can successfully enlarge difference in the refractive indices of the core region and clad region, which is preferable in that strictly confining light within the core region and thus improving the performance of optical fiber. Formation of the clad region with the polymer having deuterium-substituted carbon atoms and halogen-substituted carbon atoms can further reduce the content of carbon-hydrogen bond in the material, which is successful in further lowering the light transmission loss. On the other hand, formation of the clad region with a non-deuterated, halogenated (meth)acrylic acid ester polymer can provide a high-performance optical fiber as described in the above at a lower cost. The halogenated (preferably fluorinated) (meth) acrylic acid ester polymer can be produced by polymerizing one or more esters of alcohols, having at least a part of hydrogen atoms thereof substituted by halogen atoms (preferably fluorine atoms), and either of acrylic acid or methacrylic acid, or by copolymerizing such ester with other monomer.

Specific examples of the monomers available for forming the core region are such as those specifically listed in the above. While specific examples of the monomers available for forming the clad region are also such as those specifically listed in the above, additional specific examples thereof include non-deuterated, halogenated propenoic acid esters as shown below.

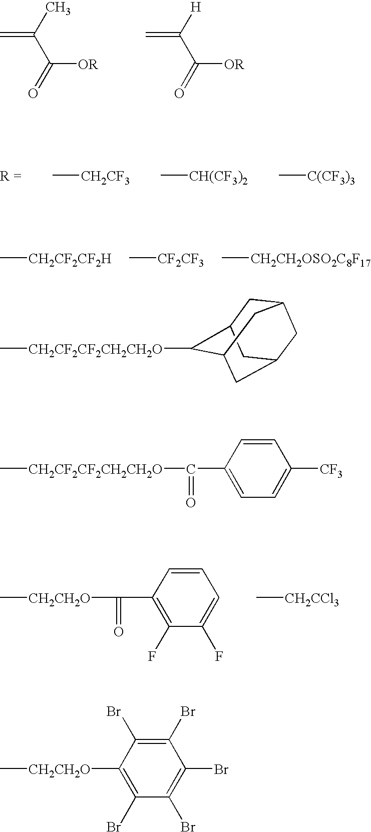

The polymer preferably used for the core region is a homopolymer or copolymer containing repetitive unit (1), (2) or (3) out from the exemplary repetitive units listed in the above. While specific examples of the polymers available for forming the clad region are also the same as described in the above, additional specific examples thereof include a homopolymer containing only fluorine atoms as the substituent (e.g., unit (10)) selected from the exemplary repetitive units (1) to (34) listed in the above, and a copolymer of a repetitive unit containing only fluorine atoms as the substituent (e.g., unit (25)) and a repetitive unit containing neither deuterium atoms nor halogen atoms in an arbitrary ratio. In particular for the clad region, homopolymers or copolymers containing the foregoing repetitive units (8), (10) or (25) are preferable.

In the third embodiment, specific examples of the low-molecular-weight organic compound (refractive index adjusting agent) to be contained in the core region are as described in the above. The refractive index can be adjusted to a desired value by controlling the concentration and distribution of the low-molecular-weight organic compound in the core region. The amount of addition thereof is properly selected depending on purpose of use and a source material for the core region to be combined with. Also in the fourth embodiment, the low-molecular-weight organic compound (refractive index adjusting agent) can be included in the core region so as to further ensure formation of refractive-index-distributed structure.

When the monomers as the source materials for the core region and clad region are polymerized, it is allowable to add a polymerization initiator or polymerization modifier (e.g., chain transfer agent) for the purpose of controlling the molecular weight suitable for heat stretching. Specific examples of the polymerization initiator and polymerization modifier are as described in the above.

Next paragraphs will describe examples of producing method of the third and fourth embodiments will be explained, however, the methods is not limited to the examples shown below.

Either the third or fourth embodiment can be produced by a method comprising a first step of producing a hollow structure (for example a cylinder) corresponding to the clad region; a second step of producing a preform which comprises areas respectively corresponded to the core region and clad region by carrying out polymerization of a polymerizable composition in the hollow portion of the structure; and a third step of processing the obtained preform into various forms. The polymerizable composition use in the second step may comprise a deuterated and halogenated (preferably fluorinated) propenoic acid ester based polymer (for example (meth)acrylate based polymer), a polymerization initiator, and a polymerization modifier for controlling a molecular weight of the obtained polymer. In case of the third embodiment, the composition contains a low molecular weight organic compound having the refractive index different from that of the ester, in case of the fourth embodiment, the composition contains two or more polymerization monomers that there is 0.05 and more disparity in refraction indices of homopolymers made of each the monomers, In the first step, a hollow structure (for example cylinder) made of a polymer is obtained. As typically described in International Patent Publication WO93/08483, a polymerizable composition containing the ester (for example a deuterated and halogenated (meth)acrylate) is put into a cylindrical polymerization vessel, and then polymerization is carried out while rotating (preferably while keeping the axis of the cylinder horizontally) the vessel to thereby form a cylinder made of a polymer. The other monomers and/or a polymerization initiator may be added to the vessel. A chain transfer agent is preferably used in the polymerization in order to control the molecular weight of an obtained polymer, thereby being in a range of 40,000 to 120,000. The composition used herein may be pre-polymerized before the polymerization so as to raise the viscosity thereof as described in JP-A No. 8-110419.

It is desirable to use a compound as a polymerization initiator, of which ten-hour, half-life decomposition temperature is equal to or lower than a boiling point of the monomer. It is to be noted now that ten-hour, half-life decomposition temperature (t_{1/2} ° C.) of the polymerization initiator means a temperature at that the polymerization initiator decomposes and reduces to the half amount for ten hours. It is more preferable to use the compound as a polymerizing initiator and to carry out the polymerization in the presence of the initiator at temperature of the range form {(t_{1/2})−20}° C. to t_{1/2} ° C.

For the case where 2,2,2-trifluoroethyl-pentadeuterium methacrylate (CD₂═C (CD₃) CO₂CH₂CF₃) is used as the ester monomer and PBD is used as polymerization initiator, the polymerization may be carried out at 100 to 110° C. for 48 to 72 hours.

A preferable range of the additional amount of the polymerization initiator may properly be determined in consideration of species of the monomer to be employed, however, in general, a desirable additional amount of the polymerization initiator is in a range from 0.10 to 1.00 wt % of the monomer, and more preferably in a range from 0.40 to 0.60 wt %.

For the purpose of completely reaction of the residual monomer or the residual polymerization initiator, it is allowable after such rotational polymerization to carry out annealing at a temperature higher than the polymerization temperature, or to remove non-polymerized components.

How dimension of the vessel, how amount of the polymerizable composition, and how many revolutions per unit of time can be determined according to how dimension of desired plastic optical member (or perform) Since the obtained hollow structure may be deformative when the vessel may get distorted by rotation, it is preferable to use a metal or glass vessel having a sufficient rigidity.

In the first step, it is also possible to produce the structure having a desired shape (cylindrical shape in this embodiment) by molding polymer using known molding technique such as extrusion molding.

In the second step, the polymerizable composition, containing a deuterated and halogenated propenoic acid ester, for example, a deuterated and halogenated (meth)acrylate, is poured into the hollow portion of the cylinder, which was obtained by the first step, corresponding to the clad region, and the polymerization of the monomer is carried out under heating. It is also allowable to add a polymerization initiator, chain transfer agent, and optional refractive index adjusting agent together with the monomer. All of the materials are preferably dewatered by the methods described in the above. A preferable range of the amount addition thereof may properly be determined typically in consideration of species of the monomer to be employed, where a desirable amount of addition of the polymerization initiator is generally in a range from 0.005 to 0.050 wt % of the monomer, and more preferably in a range from 0.010 to 0.020 wt %, and a desirable amount of addition of the chain transfer agent is generally in a range from 0.10 to 0.40 wt % of the monomer, and more preferably in a range from 0.15 to 0.30 wt %. In case of composition containing a refractive index adjusting agent, the additional amount of the agent may be determined according to using.

In the second step, the polymerization of the monomer as the source material, which is poured into the hollow portion of the cylinder, is carried out. It is preferable from the view point of residues after polymerization to carry out the polymerization by a method based on the interfacial gel polymerization process which is solvent-free, disclosed in International Patent Publication No. WO93/08488. In the interfacial sol polymerization process, the polymerization of the polymerizable monomer proceeds along the radial direction of the cylinder from the inner wall thereof, of which viscosity is high, towards the center due to gel effect.

When the polymerizable monomer added with a refractive index adjusting agent is used in the polymerization, as the third embodiment, the polymerization proceeds in a way such that the monomer having a higher affinity to the polymer, of which the cylinder is made predominantly, exists in larger ratio on the inner wall of the cylinder and then polymerizes, so as to produce on the outer periphery a polymer having a lower content of the refractive index adjusting agent. Ratio of the refractive index adjusting agent in the resultant polymer increases towards the center. This successfully creates the distribution of refractive index adjusting agent and thus introduces the distribution of refractive index within the area corresponding to the core region.

For the case where two or more polymerizable monomers are used, as the fourth embodiment, the monomers have different degrees of polymerization ability due to differential affinity to the polymer of the cylinder and differential diffusion (because of differences of intrinsic volumes and solubility parameters of the monomers) in a gel. Thus the monomer having a higher affinity to the polymer of which the cylinder is made predominantly segregates on the inner wall of the cylinder and then polymerizes, so as to produce a polymer having a higher content of such monomer. Ratio of the high-affinity monomer in the resultant polymer reduces towards the center. Since there are 0.05 and more disparity between each homopolymers of the monomers, the distribution of refractive index can be created along the interface with the clad region to the center of the core region.

Not only the distribution of refractive index is induced into the area corresponding to the core region through the second step, but also the distribution of thermal behavior since the areas having different refractive indices are also different in the thermal behavior. If the polymerization in the second step is carried out at a constant temperature, the response property against the mass shrinkage which occurs in the polymerization reaction process may vary depending on the thermal behaviors, and thereby air bubbles or micro-gaps may generate in the obtained perform, and drawing under heating of such preform may result in that the obtained fiber has a lot of air bubbles formed therein. It the polymerization in the second step is carried out at too low temperature, the productivity may considerably lower due to low polymerization efficiency, or the light transmission performance of the resultant optical member may lower due to incomplete polymerization. On the contrary, if the polymerization in the second step is carried out at too high initial polymerization temperature, the initial polymerization rate maybe so fast that the mass shrinkage of the core region cannot be reduced by a relaxation response, and as a result a lot of air bubbles may generate in the core region. Therefore, it is preferable to carry out the polymerization at a proper temperature for the used monomers. For the case where 2,2,2-trifluoroethyl-pentadeuterium methacrylate (CD₂═C(CD₃)CO₂CH₂CF₃) is used as the monomer, the polymerization may be carried out at 50 to 150° C., preferably 80 to 120° C., for 48 to 72 hours.

In order to prevent blister formation, the monomers may be dewatered and or deaerated before the monomers are poured into the follow of the cylinder.

It is also desirable to use a compound as a polymerization initiator, of which ten-hour, half-life decomposition temperature is equal to or lower than a boiling point of the monomers, and to carry out the polymerization in the presence of the initiator for a period which is equal to 10% and more of the initiator's half-life period. To carry out polymerization under the foregoing conditions can reduce the initial polymerization speed and can improve the response property against the mass shrinkage, which consequently reduces the introduction of air bubbles into the preform due to the mass shrinkage, and thus raises the productivity. For the case where 2,2,2-trifluoroethyl-pentadeuterium methacrylate (CD₂═C(CD₃)CO₂CH₂CF₃) is used as the monomer, PBD and PHV can be selected as available ones from the above-listed polymerization initiators such that having a ten-hour, half-life decomposition temperature which is equal to or above the boiling point of the monomer. For the case where PBD is used as the polymerization initiator, the polymerization is preferably allowed to proceed while keeping the initial polymerization temperature at 100 to 110° C. for 48 to 72 hours, and further allowed to proceed at a temperature elevated to 120 to 140° C. for 24 to 48 hours. For the case where PHV is used as the polymerization initiator, the polymerization is preferably allowed to proceed while keeping the initial polymerization temperature at 100 to 110° C. for 4 to 24 hours, and further allowed to proceed at a temperature elevated to 120 to 140° C. for 24 to 48 hours. The temperature elevation may be effected either in a step-wise manner or in a continuous manner, where shorter time for the elevation is preferable.

In the second step, it is preferable to carry put the polymerization under pressure (herein after referred as “pressurized polymerization”). In case of the pressurized polymerization, it is preferable to place the cylinder in the hollow space of the jig, and to carry out the polymerization while keeping the cylinder as being supported by the jig. While the pressurized polymerization is being carried out in a hollow portion of the structure corresponding to the clad region, the structure is kept as being inserted in the hollow space of the jig, and the jig prevents the shape of the structure from being deformed due to pressure. The jig is preferably shaped as having a hollow space in which the structure can be inserted, and the hollow space preferably has a profile similar to that of the structure. Since the structure corresponding to the clad region is formed in a cylindrical form in the present embodiment, it is preferable that also the jig has a cylindrical form. The jig can suppress deformation of the cylinder during the pressurized polymerization, and supports the cylinder so as to relax the shrinkage of the area corresponding to the core region with the progress of the pressurized polymerization. For the case where the cylinder is supported as being adhered to the jig, the cylinder will be unsuccessful in relaxing the shrinkage of the area corresponding to the core region as described in the above, so that voids tend to generate at the central portion. It is therefore preferable that the jig has a hollow space having a diameter larger than the outer diameter of the cylinder corresponding to the clad layer, and that the jig supports the cylinder corresponding to the clad layer in a non-adhered manner. Since the jig has a cylindrical form in the present embodiment, the inner diameter of the jig is preferably larger by 0.1 to 40% than the outer diameter of the cylinder corresponding to the clad region, and more preferably larger by 10 to 20%.

The cylinder corresponding to the clad region can be placed in a polymerization vessel while being inserted in the hollow space of the jig. In the polymerization vessel, it is preferable that the cylinder is housed so as to vertically align the height-wise direction thereof, After the cylinder is placed, while being supported by the jig, in the polymerization vessel, the polymerization vessel is pressurized. The pressurizing of the polymerization vessel is preferably carried out using an inert gas such as nitrogen, and thus the pressurized polymerization preferably is carried out under an inert gas atmosphere. While a preferable range of the pressure during the polymerization may vary with species of the monomer, it is generally 0.05 to 1.0 MPa or around.

A perform for a plastic optical fiber can be obtained through the first and second steps. The glass transition point of the polymer for the core region is preferably in a range of 60 to 80° C., more preferably 80 to 180° C. The molecular weight of the polymer for the core region is preferably in a range of 40.000 to 300,00, more preferably 50,00 to 300,000. A preferable range of refractive index difference between core and clad region may vary according to the application of the fiber, however, in general, the difference is preferable in a range of 0.001 to 0.1, more preferable in a range of 0.005 to 0.08.

In these embodiments, the polymerization is carried out under heating, however, the polymerization may be carried out by irradiation of UV light and the like.

In the third step, a desired optical transmission member can be obtained by processing the preform produced through above steps. For example, slicing the preform gives planar lens, and drawing under fusion gives plastic optical fiber. Another optical member such as Light guide members can also be produced by processing the obtained perform.

A plastic optical fiber can be obtained by drawing the perform under heating. While the heating temperature during the drawing may properly be determined in consideration of source material of the preform, a generally preferable range thereof is 180 to 250° C. Conditions for the drawing (drawing temperature, etc.) may properly be determined in consideration of diameter of the obtained preform, desirable diameter of the plastic optical fiber, and source materials used. For example, the drawing tension can be set to 10 g or above in order to orient molten plastic as described in JP-A No. 7-234322, and preferably set to 100 g or below so that strain does not remain after the spinning as disclosed in JP-A No. 7-234324. The perform may be pre-heated during drawing as disclosed in JP-A No. 8-106015. As for the fiber obtained by the foregoing method, bending property and lateral pressure property thereof can be improved by specifying break elongation and hardness of the obtained element fiber as described in JP-A No. 7-244220.

The plastic optical fiber after being processed in the third step can directly be subjected, without any modification, to various applications. The fiber may also be subjected to various applications in a form of having on the outer surface thereof a covering layer or fibrous layer, and/or in a form having a plurality of fibers bundled for the purpose of protection or reinforcement.

For the case where a coating is provided to the element wire, the covering process is such that running the element wire through a pair of opposing dies which has a through-hole for passing the element fiber, filling a molten polymer for the coating between the opposing dies, and moving the element fiber between the dies. The covering layer is preferably not fused with the element fiber in view of preventing the inner element fiber from being stressed by bending. In the covering process, the element fiber may be thermally damaged typically through contacting with the molten polymer. It is therefore preferable to set the moving speed of the element fiber so as to minimize the thermal damage, and to select a polymer for forming the covering layer which can be melted at a low temperature range. The thickness of the covering layer can be adjusted in consideration of fusing temperature of polymer for forming the covering layer, drawing speed of the element fiber, and cooling temperature of the covering layer.

Other known methods for forming the covering layer on the fiber include a method by which a monomer coated on the optical member is polymerized, a method of winding a sheet around, and a method of passing the optical member into a hollow pipe obtained by extrusion molding.

Coverage of the element fiber enables preparing of plastic optical fiber cable. Styles of the coverage include contact coverage in which plastic optical fiber is covered with a cover material so that the boundary of the both comes into close contact over the entire circumference; and loose coverage having a gap at the boundary of the cover material and plastic optical fiber. The contact coverage is generally preferable since the loose coverage tends to allow water to enter into the gap from the end of the cover layer when a part of the cover layer is peeled off typically at the coupling region with a connector, and to diffuse along the longitudinal direction thereof. The loose coverage in which the coverage and element fiber are not brought into close contact, however, is preferably used in some purposes since the cover layer can relieve most of damages such as stress or heat applied to the cable, and can thus reduce damages given on the element fiber. The diffusion of water from the end plane is avoidable by filling the gap with a fluid gel-form, semi-solid or powdery material. The coverage with higher performance will be obtained if the semi-solid or powdery material is provided with functions other than water diffusion preventive function, such as those improving heat resistancer mechanical properties and the like.

The loose coverage can be obtained by adjusting position of a head nipple of a crosshead die, and by controlling a decompression device so as to form the gap layer. The thickness of the gap layer can be adjusted by controlling the thickness of the nipple, or compressing/decompressing the gap layer.

It is further allowable to provide another cover layer (secondary cover layer) so as to surround the existing cover layer (primary cover layer). The secondary cover layer may be added with flame retarder, UV absorber, antioxidant, radical trapping agent, lubricant and so forth, which may be included also in the primary cover layer so far as a satisfactory level of the anti-moisture-permeability is ensured.

While there are known resins or additives containing bromine or other halogen or phosphorus as the flame retarder, those containing metal hydroxide are becoming a mainstream from the viewpoint of safety such as reduction in emission of toxic gas. The metal hydroxide has crystal water in the structure thereof and this makes it impossible to completely remove the adhered water in the production process, so that the flame-retardant coverage is preferably provided as an outer cover layer (secondary cover layer) surrounding the anti-moisture-permeability layer (primary cover layer) of the present invention.

It is still also allowable to stack cover layers having a plurality of functions. For example, besides flame retardation, it is allowable to provide a barrier layer for blocking moisture absorption by the element fiber or moisture absorbent for removing water, which are typified by hygroscopic tape or hygroscopic gel, within or between the cover layers. It is still also allowable to provide a flexible material layer for releasing stress under bending, a buffer material such as foaming layer, and a reinforcing layer for raising rigidity, all of which may be selected by purposes. Besides resin, a highly-elastic fiber (so-called tensile strength fiber) and/or a wire material such as highly-rigid metal wire are preferably added as a structural material to a thermoplastic resin, which reinforces the mechanical strength of the obtained cable.

Examples of the tensile strength fiber include aramid fiber, polyester fiber and polyamide fiber. Examples of the metal wire include stainless wire, zinc alloy wire and copper wire. Both of which are by no means limited to those described in the above. Any other protective armor such as metal tube, subsidiary wire for aerial cabling, and mechanisms for improving workability during wiring can be incorporated.

Types of the cable include collective cable having element fibers concentrically bundled; so-called tape conductor having element fibers linearly aligned therein; and collective cable further bundling them by press winding or wrapping sheath; all which can properly be selected depending on applications.

The optical member of the present invention is available as an optical fiber cable for use in a system for transmitting light signal, which system comprises various light-emitting element, light-receiving element, other optical fiber, optical bus, optical star coupler, light signal processing device, optical connector for connection and so forth. Any known technologies may be applicable while making reference to “Purasuchikku oputicaru Faiba no Kiso to Jissai (Basics and Practice of Plastic Optical Fiber)”, published by N.T.S. Co., Ltd.; optical bus typically described in JP-A Nos. 10-123350, 2002-90571 and 2001-290055; optical branching/coupling device typically described in JP-A Nos. 2001-74971, 2000-329962, 2001-74966, 2001-74968, 2001-318263 and 2001-311840; optical star coupler typically described in JP-A No. 2000-241655, light signal transmission device and optical data bus system typically described in JP-A Nos. 2002-62457, 2002-101044 and 2001-305395; light signal processor typically described in JP-A No. 2002-23011; light signal cross-connection system typically described in JP-A No. 2001-86537; optical transmission system typically described in JP-A No. 2002-26815; and multi-function system typically described in JP-A Nos. 2001-339554 and 2001-339555.

### EXAMPLES

The present invention will specifically be described referring to the specific examples. It is to be noted that any materials, reagents, ratio of use, operations and so forth can properly be altered without departing from the spirit of the present invention. The scope of the present invention is therefore by no means limited to the specific examples shown below.

### Example 1

Production of Optical Fiber

(Production of Clad Region)

Each of the monomers listed in the “clad region” column in Table 1, a polymerization initiator in an amount of 0.5 wt % of the monomer, and a chain transfer agent in an amount of 0.28 wt % of the monomer were mixed, and the mixture was stirred under a dark condition. The mixture was then poured into a sufficiently-rigid cylindrical vessel having 50 mm in inner diameter and 600 mm in length, which inner diameter corresponds with the outer diameter of the preform to be obtained. The mixture was allowed to polymerize under heating at 70° C. for three hours while holding the vessel horizontally and rotating it at a speed of rotation of 3,000 rpm, which was followed by annealing at 90° C. for 24 hours to thereby obtain hollow cylinders comprised of homopolymers of the individual monomers.

(Production of Core Region)

Next, each of the monomers listed in the “core region” column in Table 1, a refractive index adjusting agent in an amount of 12 wt % of the monomer, a polymerization initiator in an amount of 0.013 wt % of the monomer, and a chain transfer agent in an amount of 0.27 wt % of the monomer were mixed, and the mixture was directly poured into the hollow region of each of the obtained hollow cylinders while being filtered through a membrane filter, based on tetrafluoroethylene, having a pore size of 0.2 μm. Each of the cylinders thus filled with the monomer and so forth was housed in a glass tube having a diameter larger by 2 mm than the outer diameter of the cylinder, and was then allowed to stand vertically in a pressure polymerization reactor. The inner atmosphere of the pressure polymerization reactor was then purged with nitrogen, pressurized up to 0.6 MPa, and the heat polymerization was allowed to proceed at 120° C. for 48 hours to thereby respectively obtain the preforms.

(Drawing Process)

The preform was drawn under heating at 200° C. to thereby obtain a plastic optical fiber of 700 to 800 μm in diameter.

[Characteristics of Optical Fiber]

Glass transition temperature (Tg) of the core region of thus obtained individual fibers, molecular weight of the polymer in the core region, refractive index (average) of the core region, refractive index of the clad region, and difference between refractive indices (An) of the core region and clad region of the obtained fibers are listed in Table 2.

Light transmission loss of the obtained fibers was also measured. The results, together with transmission band, are shown in Table 3.

TABLE 1

| | | | | Core Region | | | |
|---|---|---|---|---|---|---|---|
| | Clad Region | | | | | | Refractive |
| | | | Chain | | | Chain | Index |
| | | Polymerization | Transfer | | Polymerization | Transfer | Adjusting |
| | Monomer | Initiator | Agent | Monomer | Initiator | Agent | Agent |
| Example 1-1 | 1 | BME | C₁₂ | 1 | BME | C₁₂ | DPS |
| Example 1-2 | 3 | BPO | C₄ | 1 | BPO | C₁₂ | DPS |
| Example 1-3 | 6 | BPO | C₄ | 1 | BPO | C₁₂ | o-DCB |
| Example 1-4 | 3 | BME | C₁₂ | 2 | BME | C₁₂ | BB |
| Example 1-5 | 4 | BPO | C₄ | 2 | BPO | C₁₂ | DPS |
| Example 1-6 | 5 | BPO | C₄ | 2 | BPO | C₁₂ | BB-d₅ |
| Example 1-7 | 7 | BME | C₁₂ | 2 | BME | C₁₂ | BB |
| Example 1-8 | 2 | BPO | C₁₂ | 3 | BPO | C₁₂ | o-DCB |
| Example 1-9 | 3 | BPO | C₄ | 3 | BPO | C₁₂ | BB-d₅ |
| Example 1-10 | 5 | BME | C₄ | 3 | BME | C₁₂ | BB-d₅ |
| Example 1-11 | 3 | BPO | C₄ | 7 | BPO | C₁₂ | BB |
| Example 1-12 | 7 | BPO | C₁₂ | 7 | BPO | C₁₂ | DPS |
| Comparative | MMA | BPO | C₁₂ | MMA | BPO | C₁₂ | DPS |
| Example 1 | | | | | | | |

The numerals in the “monomer” column in Table 1 respectively represent the compounds below.

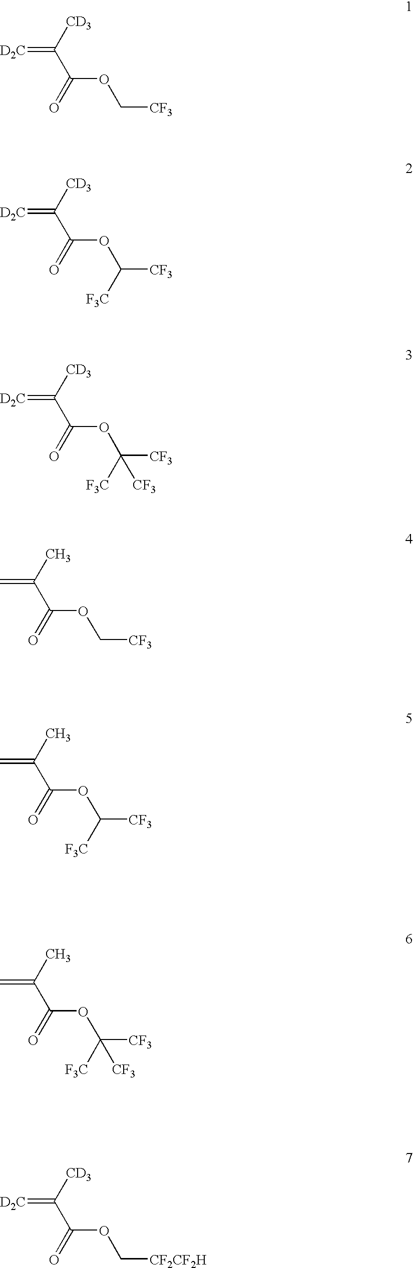

The abbreviations in the “refractive index adjusting agent” column and the “polymerization initiator” column in Table 1 respectively represent the compounds below:

DPS: diphenylsulfide;

BB-d₅: bromobenzene-d₅;

o-DCB; ortho-dichlorobenzene;

BPO: benzoyl peroxide; and

BME: benzoylmethyl ether.

In Table 1, the abbreviations in the “chain transfer agent” column respectively represent thiol compounds having correspondent number of carbon atoms.

TABLE 2

| | Core Region | | | | |
|---|---|---|---|---|---|
| | Glass | | | Clad | |
| | Transition | | Re- | Region | |
| | Temperature | *Molecular | fractive | Refractive | |
| | (Tg) | Weight | Index | Index | Δn |
| Example 1-1 | 58° C. | 98000 | 1.431 | 1.428 | 0.013 |
| Example 1-2 | 58° C. | 103000 | 1.428 | 1.402 | 0.026 |
| Example 1-3 | 107° C. | 109000 | 1.427 | 1.402 | 0.025 |
| Example 1-4 | 72° C. | 107000 | 1.420 | 1.402 | 0.018 |
| Example 1-5 | 74° C. | 118000 | 1.432 | 1.418 | 0.014 |
| Example 1-6 | 74° C. | 95000 | 1.420 | 1.407 | 0.013 |
| Example 1-7 | 73° C. | 126000 | 1.445 | 1.432 | 0.013 |
| Example 1-8 | 109° C. | 89000 | 1.421 | 1.408 | 0.013 |
| Example 1-9 | 110° C. | 103000 | 1.415 | 1.402 | 0.013 |
| Example 1-10 | 110° C. | 114000 | 1.420 | 1.407 | 0.013 |
| Example 1-11 | 55° C. | 97000 | 1.421 | 1.402 | 0.019 |
| Example 1-12 | 55° C. | 132000 | 1.445 | 1.432 | 0.013 |
| Comparative | 105° C. | 105000 | 1.504 | 1.492 | 0.012 |
| Example 1 | | | | | |

*Weight-Average Molecular Weight

TABLE 3

| | 780 nm | | 850 nm | |
|---|---|---|---|---|
| | Light | | Light | |
| | Transmission | Band | Transmission | Band |
| | Loss (dB/km) | (GHz/km) | Loss (dB/km) | (GHz/km) |
| Example 1-1 | 105 | 1.0 | 210 | 1.0 |
| Example 1-2 | 100 | 1.0 | 180 | 1.0 |
| Example 1-3 | 110 | 1.0 | 305 | 1.0 |
| Example 1-5 | 85 | 1.0 | 310 | 1.0 |
| Example 1-10 | 70 | 1.0 | 250 | 1.0 |
| Example 1-11 | 98 | 1.0 | 198 | 1.0 |
| Comparative | 1070 | 1.0 | 10,000 | 1.0 |
| Example 1 | | | | |

### Example 2

Production of Optical Fiber

(Production of Clad Region)

Each of the monomers listed in the “clad region” column in Table 4, a polymerization initiator in an amount of 0.5 wt % of the monomer, and a chain transfer agent in an amount of 0.28 wt % of the monomer were mixed, and the mixture was stirred under a dark condition. The mixture was then poured into a sufficiently-rigid cylindrical vessel having 50 mm in inner diameter and 600 mm in length, which inner diameter corresponds with the outer diameter of the preform to be obtained. The mixture was allowed to polymerize under heating at 70° C. for three hours while holding the vessel horizontally and rotating it at a speed of rotation of 3,000 rpm, which was followed by annealing at 90° C. for 24 hours to thereby obtain hollow cylinders comprised of homopolymers of the individual monomers.

(Production of Core Region)

Next, each of the monomers listed in the “core region” column in Table 4, a refractive index adjusting agent in an amount of 12 wt % of the monomer, a polymerization initiator in an amount of 0.013 wt % of the monomer, and a chain transfer agent in an amount of 0.27 wt % of the monomer were mixed, and the mixture was directly poured into the hollow region of each of the obtained hollow cylinders while being filtered through a membrane filter, based on tetrafluoroethylene, having a pore size of 0.2 μm. Each of the cylinders thus filled with the monomer and so forth was housed in a glass tube having a diameter larger by 2 mm than the outer diameter of the cylinder, and was then allowed to stand vertically in a pressure polymerization reactor. The inner atmosphere of the pressure polymerization reactor was then purged with nitrogen, pressurized up to 0.6 MPa, and the heat polymerization was allowed to proceed at 120° C. for 48 hours to thereby respectively obtain the preforms having the core regions comprised of the polymers shown in the “core region” column in Table 4.

(Drawing Process)

The preform was drawn under heating at 200° C. to thereby obtain a plastic optical fiber of 700 to 800 μm in diameter.

[Characteristics of Optical Fiber]

Glass transition temperature of the core region of thus obtained individual fibers, molecular weight of the polymer in the core region, refractive index (average) of the core region, refractive index of the clad region, and difference between refractive indices (Δn) of the core region and clad region of the obtained fibers are listed in Table 5.

Light transmission loss of the obtained fibers was also measured. The results, together with transmission band, are shown in Table 6.

Comparative Examples 2-2 and 2-3 could not be evaluated due to insolubility of the refractive index adjusting agent.

TABLE 4

| | | | | | Core Region | | | | | |
|---|---|---|---|---|---|---|---|---|---|---|
| | Clad Region | | | | | | | Refractive | | |
| | | | *Chain | Amount | | | Chain | Index | **Amount | |
| | | Polymerization | Transfer | of F | | Polymerization | Transfer | Adjusting | of H | N_{X}/ |
| | Polymer | Initiator | Agent | [mg/g] | Polymer | Initiator | Agent | Agent | [mg/g] | [N_{H} + N_{D}] |
| Example 2-1 | 10 | PBO | C₁₂ | 365 | 1 | PBI | C₁₂ | DPS | 9.2 | 0.288 |
| Example 2-2 | 8 | BPO | C₄ | 159 | 2 | PBI | C₁₂ | BB-d₅ | 17.3 | 0.243 |
| Example 2-3 | 9 | BME | C₁₂ | 321 | 3 | BME | C₁₂ | DPS | 18.3 | 0.780 |
| Example 2-4 | 9 | BPO | C₁₂ | 356 | 4 | BPO | C₁₂ | o-DCB | 14.1 | 0.250 |
| Example 2-5 | 8 | BME | C₁₂ | 159 | 5 | BPO | C₁₂ | DPS | 13.0 | 0.371 |
| Example 2-6 | 10 | BPO | C₄ | 365 | 6 | BME | C₁₂ | BB-d₅ | 12.7 | 0.250 |
| Example 2-7 | 8 | BPO | C₄ | 159 | 7 | BPO | C₁₂ | DPS | 53.5 | 0.343 |
| Example 2-8 | 11 | BPO | C₁₂ | 294 | 11 | BPO | C₁₂ | COMPOUND A | 25.8 | 0.300 |
| Comparative | PMMA | BPO | C₁₂ | 0 | PMMA | BPO | C₁₂ | DPS | 80.5 | 0 |
| Example 2-1 | | | | | | | | | | |
| Comparative | Homo- | BPO | C₁₂ | 473 | Homo- | BPO | C₁₂ | DPS | 4.1 | 1,000 |
| Example 2-2 | polymer | | | | polymer | | | | | |
| | of | | | | of | | | | | |
| | Monomer 3 | | | | Monomer 3 | | | | | |
| Comparative | Homo- | BPO | C₁₂ | 473 | Homo- | BPO | C₁₂ | COMPOUND A | 4.1 | 1,000 |
| Example 2-3 | polymer | | | | polymer | | | | | |
| | of | | | | of | | | | | |
| | Monomer 3 | | | | Monomer 3 | | | | | |

*Amount of F atoms contained in a polymer of a clad portion
**Amount of H atoms contained in a polymer of a core portion

In Table 4, the numerals in the “polymer” column respectively represent the polymers below. “Unit” refers to the foregoing examples of the repetitive unit, and the numerals following the “unit” represent the individual example numbers. The monomers used for fabricating the preforms are those of acrylic-acid-ester-base or methacrylic-acid-ester-base capable of producing the individual repetitive unit by polymerization.

Polymer 1 a copolymer of Monomer Unit 1 (70 molar %) and Monomer Unit 11 (30 molar %)

Polymer 2 : a copolymer of Monomer Unit 1 (60 molar %), Monomer Unit 11 (30 molar %) and Monomer Unit 29 (10 molar %)

Polymer 3 : a copolymer of Monomer Unit 4 (55 molar %), Monomer Unit 11 (25 molar %) and Monomer Unit 29 (20 molar %)

Polymer 4 : a copolymer of Monomer Unit 2 (50 molar %) and Monomer Unit 11 (50 molar %)

Polymer 5: a copolymer of Monomer Unit 14 (90 molar %) and Monomer Unit 23 (10 molar %)

Polymer 6 : a copolymer of Monomer Unit 6 (50 molar %) and Monomer Unit 29 (50 molar %)

Polymer 7: a copolymer of Monomer Unit 3 (40 molar %) and Monomer Unit 29 (60 molar %)

Polymer 8: a copolymer of Monomer Unit 8 (50 molar %) and Monomer Unit 29 (50 molar %)

Polymer 9: a copolymer of Monomer Unit 25 (60 molar %) and Monomer Unit 29 (40 molar %)

Polymer 10 : a homopolymers of Monomer Unit 10

Polymer 11 a copolymer Monomer Unit 3 (50 molar %) and Monomer Unit 32 (50 molar %)

It is also to be noted that the abbreviations in the “refractive index adjusting agent” column and in the “polymerization initiator” column in Table 4 respectively denote the compounds below:

DPS: diphenyl sulfide;

BB-d₅: bromobenzen-d₅;

o-DCB: ortho-dichlorobenzene;

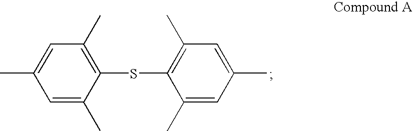

BPO: benzoyl peroxide; and

BME: benzoylmethyl ether.

The abbreviations in the “chain transfer agent” column in Table 4 respectively represent thiol compounds having correspondent number of carbon atoms.

In Table 4, N, represents the number of halogen atoms, N_{H} represents the number of hydrogen atoms, and N_{D} represents the number of deuterium atoms, respectively contained in the polymer.

TABLE 5

| | Core Region | | | | |
|---|---|---|---|---|---|
| | Glass | | | Clad | |
| | Transition | | | Region | |
| | Temperature | *Molecular | Refractive | Refractive | |
| | (Tg) | Weight | Index | Index | Δn |
| Example 2-1 | 84° C. | 98000 | 1.445 | 1.424 | 0.021 |
| Example 2-2 | 88° C. | 103000 | 1.480 | 1.456 | 0.024 |
| Example 2-3 | 110° C. | 109000 | 1.450 | 1.436 | 0.014 |
| Example 2-4 | 75° C. | 107000 | 1.450 | 1.436 | 0.014 |
| Example 2-5 | 100° C. | 118000 | 1.476 | 1.456 | 0.020 |
| Example 2-6 | 74° C. | 95000 | 1.458 | 1.424 | 0.034 |
| Example 2-7 | 100° C. | 126000 | 1.469 | 1.456 | 0.013 |
| Example 2-8 | 84° C. | 103000 | 1.423 | 1.403 | 0.020 |
| Comparative | 105° C. | 105000 | 1.504 | 1.492 | 0.012 |
| Example 2-1 | | | | | |

*Weight-average molecular weight

TABLE 6

| | | | | | *Increase of |
|---|---|---|---|---|---|
| | 780 nm | | 850 nm | | Light |
| | Light | | Light | | Transmission |
| | Transmission | Band | Transmission | Band | Loss at |
| | Loss (dB/km) | (GHz/km) | Loss (dB/km) | (GHz/km) | 850 nm (dB/km) |
| Example 2-1 | 85 | 1 | 530 | 1 | 350 |
| Example 2-3 | 100 | 1.5 | 880 | 1 | 330 |
| Example 2-4 | 110 | 1.5 | 480 | 1 | 220 |
| Example 2-7 | 150 | 1 | 1270 | 1 | 230 |
| Example 2-8 | 103 | 1 | 630 | 1 | 190 |
| Comparative | 1070 | 1 | 10,000 | 1 | 720 |
| Example 2-1 | | | | | |

*After 240 hr, at 25° C., 95RH %

### Example 3

Production of Optical Fiber

(Production of Clad Region)

Each of the monomers listed in the “clad region” column in Table 7, a polymerization initiator in an amount of 0.5 wt % of the monomer, and a chain transfer agent in an amount of 0.28 wt % of the monomer were mixed, and the mixture was stirred under a dark condition. The mixture was then poured into a sufficiently-rigid cylindrical vessel having 50 mm in inner diameter and 600 mm in length, which inner diameter corresponds with the outer diameter of the preform to be obtained. The mixture was allowed to polymerize under heating at 70° C. for three hours while holding the vessel horizontally and rotating it at a speed of rotation of 3,000 rpm, which was followed by annealing at 90° C. for 24 hours to thereby obtain hollow cylinders comprised of homopolymers of the individual monomers.

(Production of Core Region)

Next, each of the monomers listed in the “core region” in Table 7, a refractive index adjusting agent in an amount of 12 wt % of the monomer, a polymerization initiator in an amount of 0.013 wt % of the monomer, and a chain transfer agent in an amount of 0.27 wt % of the monomer were mixed, and the mixture was directly poured into the hollow region of each of the obtained hollow cylinders while being filtered through a membrane filter, based on tetrafluoroethylene, having a pore size of 0.2 μm. Each of the cylinders thus filled with the monomer and so forth was housed in a glass tube having a diameter larger by 2 mm than the outer diameter of the cylinder, and was then allowed to stand vertically in a pressure polymerization reactor. The inner atmosphere of the pressure polymerization reactor was then purged with nitrogen, pressurized up to 0.6 MPa, and the heat polymerization was allowed to proceed at 120° C. for 48 hours to thereby respectively obtain the preforms.

(Drawing Process)

The preform was drawn under heating at 200° C. to thereby obtain a plastic optical fiber of 700 to 800 μm in diameter.

[Characteristics of Optical Fiber]

Glass transition temperature of the core region of thus obtained individual fibers, molecular weight of the polymer in the core region, refractive index (average) of the core region, refractive index of the clad region, and difference between refractive indices (Δn) of the core region and clad region of the obtained fibers are listed in Table 8.

Light transmission loss of the obtained fibers was also measured at 650 nm and 850 nm. The results, together with transmission band, are shown in Table 9.

TABLE 7

| | Clad Region | | | Core Region | | |
|---|---|---|---|---|---|---|
| | | | Chain | | | Chain |
| | | Polymerization | Transfer | | Polymerization | Transfer |
| | Monomer | Intiator | Agent | Monomer | Intiator | Agent |
| Example 3-1 | 5 | BPO | C₁₂ | 1/4 = 80/20 | BPO | C₁₂ |
| Example 3-2 | 6 | BME | C₄ | 2/3/8 = 40/25/35 | BPO | C₁₂ |
| Example 3-3 | 1/5 = 50/50 | BPO | C₁₂ | 1/4/7 = 70/20/10 | BME | C₁₂ |
| Comparative | MMA | BPO | C₁₂ | MMA/7 = 70/30 | BPO | C₁₂ |
| Example 3 | | | | | | |

It is to be noted that the numerals in the “monomer” column in Table 7 respectively denote the compounds below, where ratio of blend is expressed in wt %.

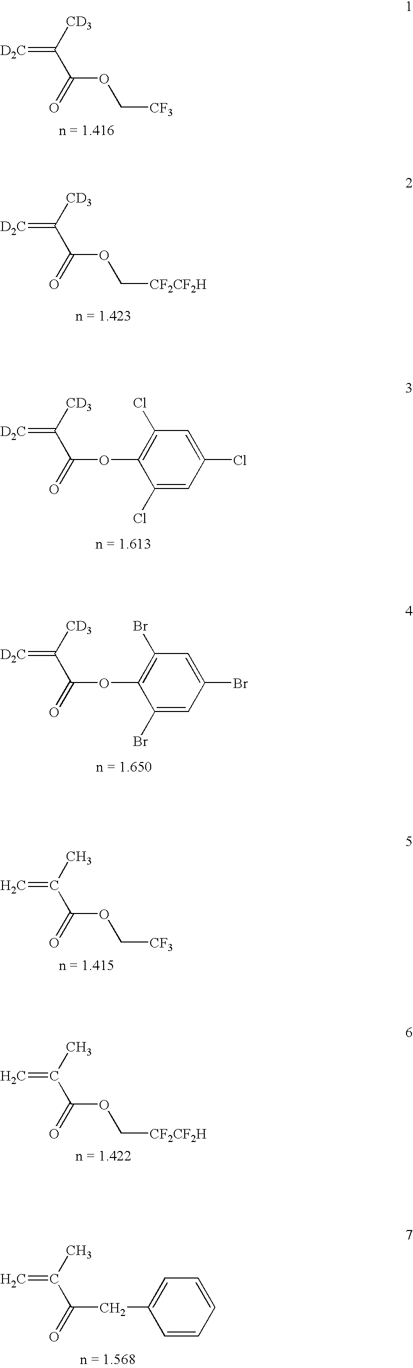

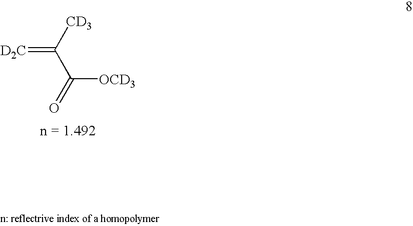

It is also to be noted that the abbreviations in the “polymerzation initiator” column in Table 7 respectively denote the compounds below:

BPO: benzoyl peroxide; and

BME: benzoyl methylether.

In Table 7, the abbreviations in the “chain transfer agent” column respectively represent thiol compounds having correspondent number of carbon atoms.

TABLE 8

| | Core Region | | | | |
|---|---|---|---|---|---|
| | Glass | | | Clad | |
| | Transition | | | Region | |
| | Temperature | *Molecular | Refractive | Refractive | |
| | (Tg) | Weight | Index | Index | Δn |
| Example 3-1 | 88° C. | 100,000 | 1.445 | 1.415 | 0.030 |
| Example 3-2 | 110° C. | 80,000 | 1.438 | 1.423 | 0.015 |
| Example 3-3 | 86° C. | 90,000 | 1.445 | 1.415 | 0.030 |
| Comparative | 89° C. | 10,000 | 1.507 | 1.492 | 0.015 |
| Example 3 | | | | | |

*Weight-average molecular weight

TABLE 9

| | |
|---|---|
| 650 nm | 850 nm |

| | Light | | Light |
|---|---|---|---|
| | Transmission | | Transmission |
| | Loss | Band | Loss |
| | (dB/km) | (GHz · km) | (dB/km) |
| Example 3-1 | 150 | 1 | 200 |
| Example 3-2 | 180 | 1 | 450 |
| Example 3-3 | 170 | 1 | 1,500 |
| Comparative | 300 | 1 | 10,000 |
| Example 3 | | | |

According to the present invention, an optical member having a reduced light transmission loss and an advanced light transmission property can be provided. The improvement effect is predominant in particular at a wavelength of 850 nm whereat emission of inexpensive laser diode occurs. The present invention is also successful in providing a polymerizable compositon and a method capable of producing the optical member having a reduced light transmission loss and an advanced light transmission property at a low cost.

Having described our invention as related to the present embodiments, it is our intention that the invention not be limited by any of the details of the description, unless otherwise specified, but rather be construed broadly within its spirit and scope as set out in the accompanying claims.

What is claimed is:

1. An optical member comprising a region having a distributed refractive index, wherein the region comprises a polymer having deuterium-substituted carbon atoms and halogen-substituted carbon atoms.

2. The optical member according to claim 1, wherein the polymer having a main chain directly substituted with deuterium atoms or bound with deuterium-substituted carbon atoms, and side chains having a halogen-substituted carbon atom.

3. The optical member according to claim 1, wherein the polymer is a polymer based on propenoic acid or derivative thereof.

4. The optical member according to claim 1, wherein the polymer comprises the repetitive unit represented by Formula (2): 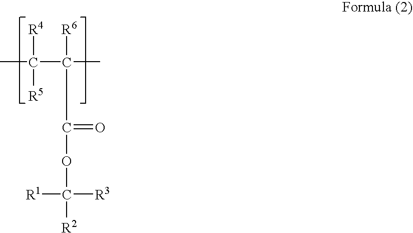
where in the formula, R¹ is a halogen atom or an alkyl group substituted by at least one halogen atom; R² and R³ independently represent a hydrogen atom, deuterium atom or alkyl group; and R⁴, R⁵ and R⁶ independently represent a hydrogen atom, deuterium atom, CH₃ group or CD₃ group, where at least one of which represents a deuterium atom or CD₃ group.

5. The optical member according to claim 1, comprising an organic compound having a low molecular weight in the region having a distributed refractive index, wherein refractive index in the region is distributed along with the concentration distribution of the organic compound.

6. The optical member according to claim 1, wherein the polymer is a copolymer of a plural propenoic ester derivatives respectively having a halogen-substituted carbon atom and a deuterium-substituted carbon atom, and refractive index in the region is distributed along with the distribution of the copolymerization ratio, of the plural propenoic ester derivatives.

7. The optical member according to claim 1, wherein refractive index in the region is distributed along with the direction from the center to the outside in cross section thereof.

8. The optical member according to claim 1, wherein the halogen atom is a chlorine or fluorine atom.

9. The optical member according to claim 1, wherein the amount of hydrogen atoms contained in the polymer is 60 mg/g or below.

10. The optical member according to claim 1, wherein a ratio of the number of halogen atoms contained in the polymer to the total number of hydrogen and deuterium atoms contained in the polymer is 0.10 to 0.90.

11. The optical member according to claim 1, comprising a core region comprising the polymer, and a clad, region cladding the core region and having different refractive index from that of the core region.

12. The optical member according to claim 11, wherein the clad region comprises a polymer having halogen-substituted carbon atoms and/or deuterium-substituted carbon atoms.

13. A polymerizable composition for preparation of optical member comprising:
an ester of an alcohol having a halogen-substituted carbon atom and a propenoic acid or derivative thereof having a deuterium-substituted carbon atom,
a polymerization initiator for the ester and
an organic compound having a low molecular weight and a different refractive index from that of a polymer of the ester.

14. The composition according to claim 13, wherein the propenoic acid or derivative thereof is a (meth)acrylic acid or derivative thereof.

15. The composition according to claim 13, wherein the alcohol was represented by Formula (I); 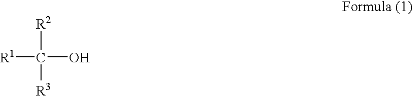
where in the formula, R¹ is a halogen atom or an alkyl group substituted by at least one halogen atom, and R² and R³ independently represent a hydrogen atom, deuterium atom or alkyl group.

16. The composition according to claim 13, wherein the halogen atom is a chlorine or fluorine atom.

17. A polymerizable composition for preparation of optical member comprising:
a plural polymerizable monomers of which homopolymers have different refractive indices by 0.005 or more each other, at least one of which is a compound having a halogen-substituted carbon atom and a deuterium-substituted carbon atom and
a polymerization initiator for the polymerizable monomers.

18. An optical member comprising a region prepared by polymerization of a composition comprising:
at least one ester of an alcohol having a halogen-substituted carbon atom and a propenoic acid or derivative thereof having a deuterium-substituted carbon atom and
a polymerization initiator for the ester;
wherein refractive index in the region is distributed along with the concentration distribution of at least one component of the composition.

19. The optical member according to claim 18, wherein the composition comprises an organic compound having a low molecular weight, and refractive index in the region is distributed along with the concentration distribution of the organic compound.

20. The optical member according to claim 18, wherein the composition comprises a plural polymerizable monomers of which homopolymers have different refractive indices by 0.005 or more each other, at least one of which is a compound having a halogen-substituted carbon atom and a deuterium-substituted carbon atom, and refractive index in the region is distributed along with the distribution of copolymerization ratio of the monomers.

21. A method for preparing an optical member comprising a region having a distributed refractive index, comprising polymerization of a composition comprising at least a polymerizable monomer having a halogen-substituted carbon atom and a deuterium-substituted carbon atom and a polymerization initiator for the polymerizable monomer, thereby preparing the region.

22. The method according to claim 21, wherein the composition comprises an organic compound having a low molecular weight, and refractive index in the region is distributed along with the concentration distribution of the organic compound.

23. The method according to claim 21, wherein the composition comprises a plurality of polymerizable monomers of which homopolymers have different refractive indices by 0.005 or more each other, at least one of which is a compound having a halogen-substituted carbon atom and a deuterium-substituted carbon atom, and refractive index in the region is distributed along with the distribution of copolymerization ratio.
